(19) United States
(12) Patent Application Publication
(10) Pub. No.: US 2005/0212951 A1
(43) Pub. Date: Sep. 29, 2005

(54) Focus adjusting method and focus adjusting apparatus

(76) Inventors: Yasuhisa Miyata, Saitama-ken (JP); Masahiro Nakahashi, Saitama-ken (JP); Mitsuhiro Kanakubo, Saitama-ken (JP)

Correspondence Address: ARENT FOX PLLC, 1050 CONNECTICUT AVENUE, N.W., SUITE 400, WASHINGTON, DC, 20036, US

(21) Appl. No.: 11/087,738

(22) Filed: Mar. 24, 2005

(30) Foreign Application Priority Data
Mar. 24, 2004 (JP) 2004-87580

(51) Int. Cl. H04N 5/232

(52) U.S. Cl. 348/345

(57) ABSTRACT

It is an object of the invention to ensure the same precision as a focus adjustment based on MTF, perform an evaluation of focus adjustment on an entire image pickup surface, and reduce the size of an apparatus for performing the focus adjustment. The focus adjusting apparatus comprises a laser beam emitting section, a beam spot area measuring section, and a lens unit adjusting section. The laser beam emitting section emits a collimated laser beam to the center of the lens unit and converge the same near the center of the image pickup surface, emits a plurality of collimated laser beams at inclined angles to the central portion of the lens unit and converge them near the edges of the image pickup surface. The beam spot area measuring section measures the areas of a plurality of beam spots formed on the image pickup surface upon converging the collimated laser beams, by image-processing an output of the image pickup element. The lens unit adjusting section is equipped with a mechanism capable of adjusting the distance and/or posture of the lens unit with respect to the image pickup surface.

### BACKGROUND OF THE INVENTION

The present invention relates to a focus adjusting method and a focus adjusting apparatus.

The present application claims priority from Japanese Application No. 2004-87580, the disclosure of which is incorporated herein by reference.

A focus adjustment performed between an image pickup element such as CCD and a lens unit is necessary in various kinds of image input devices, particularly in manufacturing a camera module. Usually, a camera module is an assembly integrally containing an image pickup lens unit and a substrate mounting an image pickup element. Such a camera module is installed not only in a digital camera but also in various portable electronic devices (such as cellular phone, portable PC, PDA and the like) having a camera function. When manufacturing such a camera module, the lens unit is held on the image pickup surface of an image pickup element while at the same time receiving a focus adjustment. In this way, the lens unit and the substrate mounting the image pickup element are integrally fixed in a focus-adjusted state.

As a method of performing a focus adjustment on a lens unit when manufacturing the aforementioned camera module, it is desired to effect a focusing not only on the center of an image pickup surface, but also on an entire image pickup surface including four corners. Further, a focusing is performed in a manner such that an object faraway from the lens can form its image on the image pickup surface. For this reason, a conventional method employs a test chart having a central portion and four corners, picks up the image of the test chart while at the same time scanning the lens unit, calculates MFT of the image pickup operation for each chart image of each chart section, thereby finding an optimum focus position, as disclosed in Japanese Unexamined Patent Application Publication No. 2002-267923.

In recent years, a camera module mounted in a portable electronic device is required to be compact in size and capable of taking picture of a highly precise fine image. Such a camera module usually employs an image pickup element having a high resolution. However, with regard to such an image pickup element having a high resolution, if it is desired to perform a focus adjustment based on the conventional MTF at an appropriate precision to satisfy the aforementioned requirements, the aforementioned test chart has to be enlarged and separated at a considerable distance from the lens unit. In fact, when a focus adjustment is performed on an image pickup element of 2-mega pixel class, such an adjustment is usually performed under a condition in which a test chart of 2-m size is separated 2 m from the lens unit. As a result, an apparatus for performing a focus adjustment which includes a mechanism for holding the test chart has to be enlarged in its size, hence requiring an enlarged space for performing such an adjustment. On the other hand, although there is a simple method for performing a focus adjustment based on an amount of a detected light of an image pickup element, since only a lower adjustment precision can be obtained as compared with the above-discussed focus adjustment based on MTF, it is impossible to perform an adequate evaluation of a focusing state with respect to an entire image pickup surface.

### SUMMARY OF THE INVENTION

The present invention is to solve the above-discussed problem and it is an object of the invention to provide an improved focus adjusting method and an improved focus adjusting apparatus for use in manufacturing a camera module, making it possible to ensure the same precision as a conventional focus adjustment based on MTF, perform an evaluation of focus adjustment on an entire image pickup surface, ensure an acceptable focusing for an object located far away, and reduce the size of an apparatus for performing the focus adjustment.

In order to achieve the above objects, the present invention is characterized by at least the following aspects.

According to one aspect of the present invention, there is provided a focus adjusting method for adjusting a focus position of a lens unit with respect to an image pickup surface of an image pickup element. This method comprises the steps of: emitting a collimated laser beam to the center of the lens unit and converging the laser beam near the center of the image pickup surface, emitting a plurality of collimated laser beams at inclined angles to the central portion of the lens unit and converging the laser beams near the edges of the image pickup surface; measuring the areas of a plurality of beam spots formed on the image pickup surface upon converging the collimated laser beams; and adjusting a distance and/or a posture of the lens unit with respect to the image pickup surface in accordance with the areas of the plurality of beam spots.

According to another aspect of the present invention, there is provided a focus adjusting apparatus for adjusting a focus position of a lens unit with respect to an image pickup surface of an image pickup element. This apparatus comprises: laser beam emitting means for emitting a collimated laser beam to the center of the lens unit and converging the laser beam near the center of the image pickup surface, emitting a plurality of collimated laser beams at inclined angles to the central portion of the lens unit and converging the laser beams near the edges of the image pickup surface; beam spot area measuring means for measuring the areas of a plurality of beam spots formed on the image pickup surface upon converging the collimated laser beams, said measuring being performed by image-processing an output of the image pickup element; and lens unit adjusting means capable of adjusting a distance and/or a posture of the lens unit with respect to the image pickup surface in accordance with a measurement result of the beam spot area measuring means.

### BRIEF DESCRIPTION OF THE DRAWINGS

These and other objects and advantages of the present invention will become clear from the following description with reference to the accompanying drawings, wherein:

FIG. 1 is an explanatory view showing a focus adjusting apparatus formed according to one embodiment of the present invention;

FIGS. 2A and 2B show an example of displaying on a monitor of the focus adjusting apparatus formed according to one embodiment of the present invention;

FIG. 3 is an explanatory view showing another embodiment of the present invention; and

FIGS. 4A and 4B are explanatory views showing one embodiment of the present invention.

### DETAILED DESCRIPTION OF THE PREFERRED EMBODIMENTS

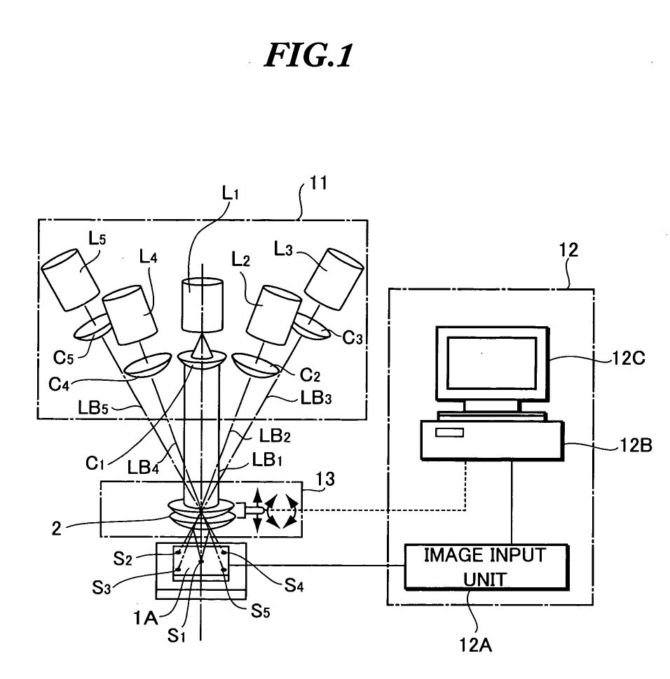

In the following, preferred embodiments of the present invention will be described with reference to the accompanying drawings. FIG. 1 is an explanatory view showing a focus adjusting apparatus formed according to one embodiment of the present invention. As shown, the focus adjusting apparatus of the invention comprises a laser beam emitting section (laser beam emitting means) 11, a beam spot area measuring section (beam spot area measuring means) 12, a lens unit adjusting section (lens unit adjusting means) 13, in a manner such that the focus position of a lens unit 2 can be adjusted with respect to an image pickup surface 1A of an image pickup element 1.

The laser beam emitting section 11 emits a collimated laser beam LB1 to the center of the lens unit 2 and converges the same near the center of the image pickup surface 1A. Meanwhile, a plurality of collimated laser beams LB2-LB5 are emitted at inclined angles to the central portion of the lens unit 2 and then converged near the edges of the image pickup surface 1A. Here, in order to form the collimated laser beams LB1-LB5, the laser beam emitting section 11 is provided with a plurality of collimator lenses C1-C5 for collimating the laser beams emitted from the laser light sources L1-L5.

The beam spot area measuring section 12 measures the areas of the plurality of beam spots s1-s5 formed on the image pickup surface 1A upon converging the collimated laser beams LB1-LB5, by image-processing an output of the image pickup element 1.

In detail, the beam spot area measuring section 12 is so formed that an output of the image pickup element 1 can be fed to its image input unit 12A containing an image pickup element driver or the like. Such an output is then fed to a computation processing device 12B having an image processing function, thereby performing an image processing in the computation processing device 12B and thus measuring the areas of the beam spots. In practice, the computation processing device 12B is connected with a monitor (monitor means) 12C, so that measurement results of beam spot areas calculated in the computation processing device 12B can be outputted to the screen of the monitor 12C.

The lens unit adjusting section 13 is equipped with a mechanism capable of adjusting a distance and/or an attitude (posture) of the lens unit 2 with respect to the image pickup surface 1A. When an adjustment is performed by the lens unit adjusting section 13, the areas of the beam spots s1-s5 will change in response to such an adjustment with respect to the preset states of the collimated laser beams L1-L5. On the other hand, in the beam spot area measuring section 12, the measurement results corresponding to such adjustment is displayed on the monitor 12C.

In this way, by performing an adjustment using the lens unit adjusting section 13 while at the same time checking the area measurement results of the beam spots s1-s5 using the monitor 12C, it is possible to manually adjust the focus position of the lens unit 2. Moreover, the computation processing device 12B has an adjustment control function for controlling the lens unit adjusting section 13 in order to obtain an optimum measurement result, thereby making it possible to automatically control the lens unit adjusting section 13 in response to the outputs of the computation processing device 12B.

A focus adjusting method using the above-discussed focus adjusting apparatus can be described as follows. Basically, the focus adjustment is performed in a manner such that all the collimated laser beams LB1-LB5 incident on the lens unit 2 are converged into light points on the image pickup surface 1A. In this way, it is possible to set the lens at a position which enables an infinitely distant object to form its image on the image pickup surface.

In more detail, one collimated laser beam LB1 is emitted to the central portion of the lens unit 2 and converged near the center of the image pickup surface 1A, while the other four collimated laser beams LB2-LB5 are emitted to the central portion of the lens unit 2 at inclined angles and converged at the four corners of the image pickup surface 1A.

Then, the beam spot area measuring section 12 operates to measure the areas of the plurality of beam spots s1-s5 formed on the image pickup surface 1A upon converging the collimated laser beams LB1-LB5, with the measurement results displayed on the screen of the monitor means 12C.

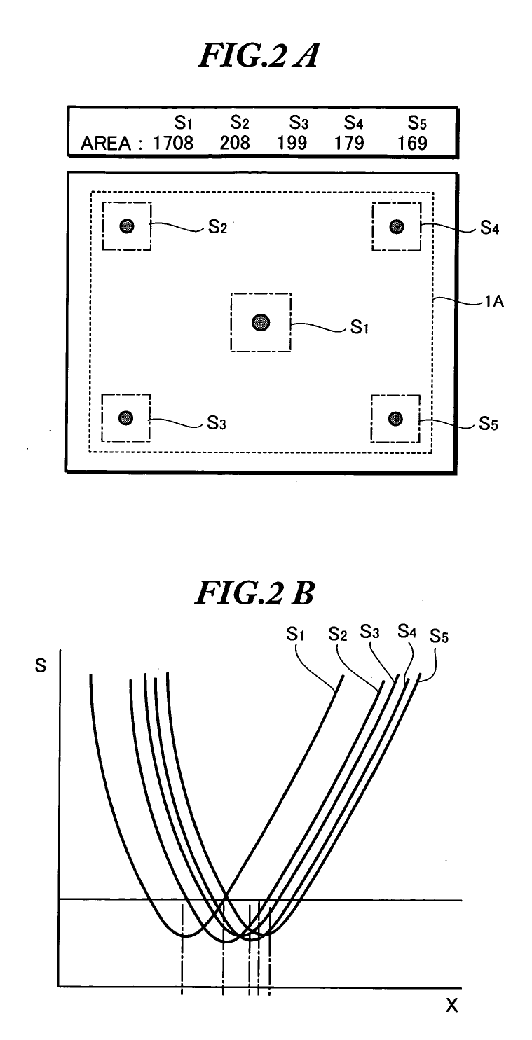

FIGS. 2A and 2B show one embodiment of the present invention. FIG. 2A shows an area corresponding to the image pickup surface 1A, indicating that such an area displays an output state of the entire image pickup surface 1A. As shown, the beam spot s1 is displayed on the center of the area, while the beam spots s1-s5 are displayed at the four corners thereof, thereby making it possible to visually check how the areas of the beam spots s1-s5 change in response to the adjustment of the lens unit 2. Moreover, since the measurement results representing the areas of the beam spots s1-s5 are numerically displayed, it is possible to perform a detailed comparison among the areas of the respective beam spots s1-s5.

FIG. 2B is a graph showing the changes of the areas (S) of the respective beam spots s1-s5 with respect to lens position (x) when the lens unit 2 is caused to scan in its axial direction. In this way, it is possible to find a lens position which minimizes the areas of the respective beam spots s1-s5, thereby making it possible to adjust the lens unit 2 based on such lens position.

However, since it is sometime impossible to find a lens position which can minimize the areas of all beam spots s1-s5, the lens unit 2 is then adjusted in a manner such that the area of the beam spot s1 formed near the center of the image pickup surface 1A becomes small and the areas of the plurality of beam spots s2-s5 formed near the edges of the image pickup surface 1A become equal to one another. In particular, by performing a comparison among the areas of the plurality of beam spots s2-s5 while at the same time adjusting the posture of the lens unit 2 in three dimensions, it is possible to obtain a correct posture of the lens unit 2.

According to the focus adjusting apparatus and the focus adjusting method of the present invention, since the collimated lights formed by laser beams having a high precision are incident on the lens unit 2 and the focus position of the lens can be made coincident with the image pickup surface 1A, it is possible to perform a focus adjustment with a high precision which allows an infinitely distant object to form its image on the image pickup surface 1A. Moreover, it is possible to position the lens by taking into account a focus adjustment to be performed not only near the center of the image pickup surface 1A, but also near the edge portions thereof including the four corners. Therefore, it becomes possible to carry out a focus adjustment as acceptable as a conventional focus adjustment based on MTF, without having to enlarge the adjusting apparatus.

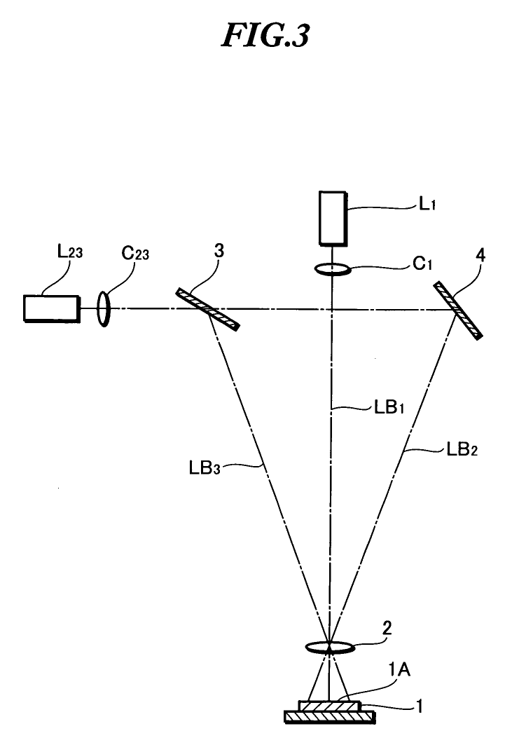

FIG. 3 is an explanatory view showing another embodiment of the present invention. In the embodiment shown in FIG. 1, the laser beam emitting section 11 comprises five laser light sources L1-L5 and the five collimator lenses C1-C5 associated with the five laser light sources L1-L5. As a result, it is necessary to adjust the laser light sources L1-L5 and the collimator lenses C1-C5 for each set of laser light source and collimator lens, and to perform a fine adjustment to obtain collimated light beams having a high precision, hence requiring considerable effort and time for an initial setting.

In order to solve the above problem, an embodiment shown in FIG. 3 employs beam dividing means for forming a plurality of collimated laser beams from a light emitted from at least one laser light source L23. Namely, in the present embodiment, a laser light emitted from the laser light source L23 is at first converted into a collimated beam by a collimator lens C23 and then divided into two beams by a half mirror 3, with one being reflected by a mirror 4 so as to be incident as the aforementioned collimated laser beam LB2 on the lens unit 2 and the other being incident as the aforementioned collimated laser beam LB3 on the same lens unit 2.

According to the present embodiment involving the beam dividing means, it is possible to obtain the same effect as obtainable in the above-described embodiment shown in FIG. 1. In addition, the number of laser light sources can be reduced, and it is possible to reduce an effort to perform an adjustment between the laser light source and the collimator lens, thereby rendering it easy to perform an initial setting.

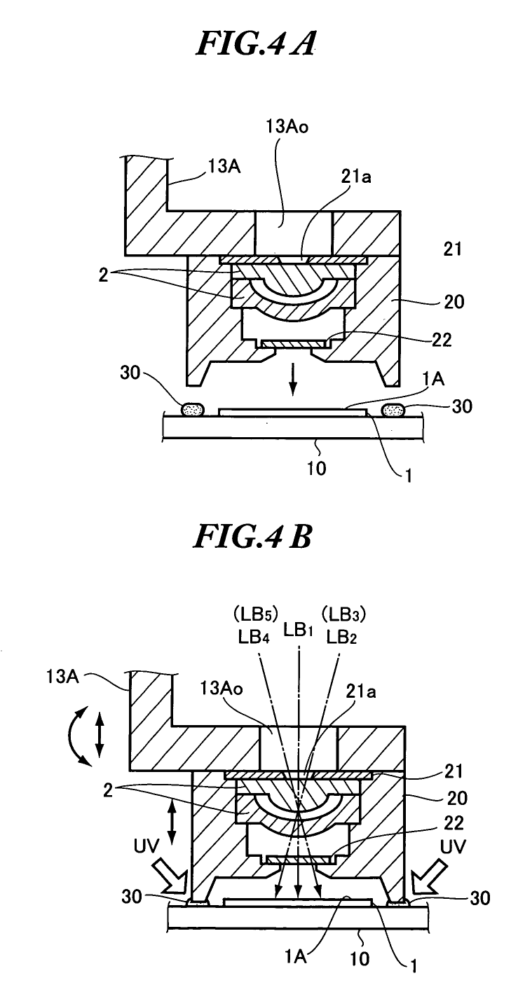

FIGS. 4A and 4B show an example of manufacturing a camera module using the above-described focus adjusting method. As shown, the camera module is formed by combining a lens holder 20 having positioned thereon the lens unit 2 with a substrate 10 mounting an image pickup element 1 such as CCD and CMOS. Here, lens holder 20 carries not only the lens unit 2 but also light converging means 21 formed with an opening 21a. The lens holder 20 also carries an optical filter 22.

At first, as shown in FIG. 4A, a lens unit holder 13A of the lens unit adjusting section 13 mentioned above is attached to the upper surface of the lens holder 20 so as to hold up the lens holder 20. Then, an ultraviolet-setting adhesive agent 30 is applied to the bonding positions on the substrate 10 mounting the image pickup element 1.

Next, as shown in FIG. 4B, the lens holder 20 held up by the lens unit holder 13A is moved to the bonding positions on the substrate 10, so that the collimated laser beams LB1-LB5 are allowed to be incident herein through the lens unit holder 13A or the opening 21a of the converging means 21. Then, while monitoring the areas of the beam spots s1-s5 mentioned above, the lens unit holder 13A is moved up and down or in the rocking direction, thereby finding an appropriate focus position of the lens unit 2.

Upon finding an optimum focus position, the lens unit holder 13A is fixed, and the adhesive agent 30 is irradiated with an ultraviolet light so as to be hardened, thereby fixing the lens holder 20 on a substrate 10. In this way, it is possible to obtain a camera module having received an appropriate focus adjustment.

Therefore, according to the present embodiment, it is possible to perform a focus adjustment capable of correctly detecting a focus position with respect to an infinitely distant object, and it is also possible to perform an appropriate focusing with respect to the entire image pickup surface 1A of the image pickup element 1. Furthermore, even when performing a focus adjustment on an image pickup element 1 having a high resolution, it is possible to save an operation space for focus adjustment.

While there has been described what are at present considered to be preferred embodiments of the present invention, it will be understood that various modifications may be made thereto, and it is intended that the appended claims cover all such modifications as fall within the true spirit and scope of the invention.

1. A focus adjusting method for adjusting a focus position of a lens unit with respect to an image pickup surface of an image pickup element, said method comprising the steps of:
emitting a collimated laser beam to the center of the lens unit and converging the laser beam near the center of the image pickup surface, emitting a plurality of collimated laser beams at inclined angles to the central portion of the lens unit and converging the laser beams near the edges of the image pickup surface;
measuring the areas of a plurality of beam spots formed on the image pickup surface upon converging the collimated laser beams; and
adjusting a distance and/or a posture of the lens unit with respect to the image pickup surface in accordance with the areas of the plurality of beam spots.

2. The focus adjusting method according to claim 1, wherein the areas of the plurality of beam spots are measured by image-processing an output of the image pickup surface.

3. The focus adjusting method according to claim 1 or 2, wherein the lens unit is adjusted in a manner such that the area of the beam spot formed near the center of the image pickup surface becomes small and the areas of the plurality of beam spots formed near the edges of the image pickup surface become equal to one another.

4. The focus adjusting method according to claims 1 and 2, wherein the plurality of beams converged near the edges of the image pickup surface consist of four laser beams converged at four corners of the image pickup surface.

5. A focus adjusting apparatus for adjusting a focus position of a lens unit with respect to an image pickup surface of an image pickup element, said apparatus comprising:
laser beam emitting means for emitting a collimated laser beam to the center of the lens unit and converging the laser beam near the center of the image pickup surface, emitting a plurality of collimated laser beams at inclined angles to the central portion of the lens unit and converging the laser beams near the edges of the image pickup surface;
beam spot area measuring means for measuring the areas of a plurality of beam spots formed on the image pickup surface upon converging the collimated laser beams, said measuring being performed by image-processing an output of the image pickup element; and
lens unit adjusting means capable of adjusting a distance and/or a posture of the lens unit with respect to the image pickup surface in accordance with a measurement result of the beam spot area measuring means.

6. The focus adjusting apparatus according to claim 5, wherein the beam spot area measuring means has monitor means for displaying a measurement result corresponding to an adjustment performed by the lens unit adjusting means.

7. The focus adjusting apparatus according to claim 5, further comprising an adjustment controlling means for controlling the lens unit adjusting means to optimize the measurement result.

8. The focus adjusting apparatus according to claim 5, wherein the laser beam emitting means comprises laser light sources and collimator lenses for collimating the laser beams emitted from the laser light sources.

9. The focus adjusting apparatus according to claim 5, wherein the laser beam emitting means has beam dividing means for forming the plurality of collimated laser beams from a light emitted from an at least one laser light source.
